(19) United States
(12) Patent Application Publication
(10) Pub. No.: US 2021/0207565 A1
(43) Pub. Date: Jul. 8, 2021

(54) Fuel Supply Device

(71) Applicant: AISAN KOGYO KABUSHIKI KAISHA, Obu-shi, Aichi-ken (JP)

(72) Inventor: Masaki IKEYA, Obushi, Aichi-ken (JP)

(73) Assignee: AISAN KOGYO KABUSHIKI KAISHA, Obu-shi, Aichi-ken (JP)

(21) Appl. No.: 16/770,061

(22) PCT Filed: Nov. 9, 2018
(86) PCT No.: PCT/JP2018/041616

§ 371 Date: Jun. 4, 2020

(30) Foreign Application Priority Data
Dec. 8, 2017 (JP) 2017-235976

(51) Int. Cl. F02M 37/00

(52) U.S. Cl. CPC F02M 37/007

(57) ABSTRACT

A fuel supply device includes a fuel tank having an opening, a lid member closing the opening, a ring member holding an outer periphery of the lid member between the fuel tank and the ring member, an electrical component disposed within the fuel tank, and a contoller configured to control the electrical component and mounted on the ring member.

### CROSS-REFERENCE TO RELATED APPLICATIONS

The present application is a National Phase entry of, and claims the benefit of, PCT Application No. PCT/JP2018/041616 filed Nov. 9, 2018, which claims priority to Japanese Patent Application No. 2017-235976 filed Dec. 8, 2017, each of which is incorporated herein by reference in its entirety for all purposes.

### STATEMENT REGARDING FEDERALLY SPONSORED RESEARCH OR DEVELOPMENT

Not applicable.

### BACKGROUND

The present disclosure generally relates to fuel supply devices.

One type of conventional fuel supply device includes a fuel tank having an opening, a lid member closing the opening, and a fuel pump disposed in the fuel tank (see, e.g. Japanese Laid-Open Patent Publication No. 2012-137020). The lid member includes a fuel delivery port, an electric connector and other components. A controller configured to control the fuel pump is disposed on the lid member. Another type of fuel supply device includes a lock ring configured to hold an outer circumferential part of the lid member between the fuel tank and the lock ring (see, e.g. Japanese Laid-Open Patent Publication No. 2016-113085).

### SUMMARY

In one aspect of this disclosure, a fuel supply device includes a fuel tank having an opening, a lid member closing the opening, a ring member holding an outer circumferential part of the lid member between the fuel tank and the ring member, and an electrical component disposed within the fuel tank. A controller for the electrical component is mounted on the ring member.

In accordance with the aspect, the mountability of the controller can be improved while disposing the controller near the fuel tank.

### BRIEF DESCRIPTION OF THE DRAWINGS

FIG. 1 is a schematic, partial cross-sectional view of a first embodiment of a fuel supply device in accordance with the principles described herein.

FIG. 2 is a plan view of the fuel supply device of FIG. 1 illustrating the fixing structure for the lid member.

FIG. 3 is a partial cross-sectional front view of the fuel supply device of FIG. 1 illustrating the fixing structure for the lid member.

FIG. 4 is a plan view of the lock ring unit of the fixing structure of FIG. 2.

FIG. 5 is a partial cross-sectional front view of the lock ring unit of FIG. 4.

FIG. 6 is a cross-sectional view of the lock ring unit of FIG. 5, taken along line VI-VI of FIG. 5.

FIG. 7 is an exploded perspective view of the twist lock mechanism of the fixing structure of FIG. 2.

FIG. 8 is a partial cross-sectional front view of a second embodiment of an arrangement structure of a controller in accordance with the principles described herein.

FIG. 9 is a partial cross-sectional front view of a third embodiment of an arrangement structure of a controller in accordance with the principles described herein.

FIG. 10 is a cross-sectional view of the controller of FIG. 8, taken along line X-X of FIG. 9.

FIG. 11 is a partial cross-sectional front view of a fourth embodiment of an arrangement structure of a controller in accordance with the principles described herein.

FIG. 12 is a partial cross-sectional front view of a fifth embodiment of an arrangement structure of a controller in accordance with the principles described herein.

FIG. 13 is a front view of a sixth embodiment of a controller mounting part of a lock ring in accordance with the principles described herein.

FIG. 14 is a cross-sectional view of the controller of FIG. 13, taken along XIV-XIV line of FIG. 13.

FIG. 15 is a front view of a seventh embodiment of a controller mounting part of a lock ring in accordance with the principles described herein.

FIG. 16 is a cross-sectional view of the controller of FIG. 15, taken along line XVI-XVI of FIG. 15.

FIG. 17 is a partial cross-sectional front view of an eighth embodiment of a controller mounting part in accordance with the principles described herein.

FIG. 18 is a partial cross-sectional right side view of the controller mounting part of FIG. 17.

FIG. 19 is a partial cross-sectional right side view of a ninth embodiment of a controller mounting part in accordance with the principles described herein.

FIG. 20 is a plan view of a tenth embodiment of a controller and a relay wire harness in accordance with the principles described herein.

FIG. 21 is a plan view of an eleventh embodiment of a controller and a relay wire harness.

FIG. 22 is a plan view of a twelfth embodiment of a fixing structure for a lid member in accordance with the principles described herein.

FIG. 23 is a plan view of a controller mounted on the lid member of FIG. 22.

FIG. 24 is a plan view of a thirteenth embodiment of a fixing structure for a lid member in accordance with the principles described herein.

FIG. 25 is a partial crossectional view of the fixing structure for the lid member of FIG. 24.

FIG. 26 is a schematic, partial cross-sectional view of a fourteenth embodiment of a fuel supply device in accordance with the principles described herein.

FIG. 27 is a plan view of a fifteenth embodiment of a fixing structure for a lid member in accordance with the principles described herein.

FIG. 28 is a partial cross-sectional front view of the fixing structure for the lid member of FIG. 27.

FIG. 29 is a partial cross-sectional front view of a sixteenth embodiment of a fixing structure for a lid member in accordance with the principles described herein.

### DETAILED DESCRIPTION

As previously described, the lid member of one type of conventional fuel supply device includes a fuel delivery port, an electric connector and other components, which may generally be referred to as “connection members.” Another type of fuel supply device includes a lock ring that holds an outer circumferential part of the lid member between the fuel tank and the lock ring.

In the case of the lid member including various connection members, the available space for mounting the controller is limited. This leads some disadvantages, such as an increase in the diameter of the lid member or restrictions on the degrees of freedom for arrangement of the connection member, which may negatively impact the mountability of the controller. Even if the diameter of the lid member is increased, it is typically necessary to increase the diameter of the opening of the fuel tank, thereby causing some disadvantages in terms of the strength, formability, and the fuel permeability of the fuel tank. Further, when the lid member is made from a resin material, the lid member may deteriorate due to heat stress caused by heat production of the controller.

When the controller is disposed at a position away from the fuel tank, the length of a wire harness between electrical components and the controller is increased, so that the cost and electromagnetic noises increases. Accordingly, it is preferable to dispose the controller near the fuel tank. Therefore, there has been a need for improved fuel supply devices.

Embodiments of the present disclosure will be described below with reference to drawings.

A first embodiment will be described. The first embodiment is a fuel supply device 10, which is mounted on a vehicle, such as an automobile, and is configured to supply fuel to an engine.

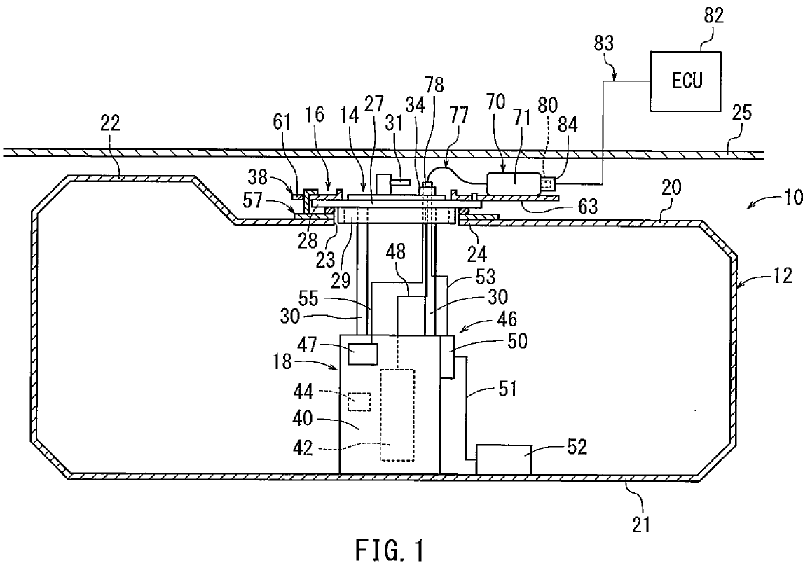

FIG. 1 is a schematic, partial cross-sectional front view of the fuel supply device 10. Upward, downward, rightward, leftward, forward and rearward directions are defined on the basis of FIG. 1. The up-down direction in FIG. 1 corresponds to the direction of gravity on a condition where the fuel supply device 10 is installed in a fuel tank 12 of the vehicle, namely, the vertical direction. In general, the remaining horizontal directions, in particular rightward, leftward, forward and rearward directions, do not limit the installation orientation of the fuel supply device 10.

As illustrated in FIG. 1, the fuel supply device 10 includes a fuel tank 12, a lid member 14, a lock ring unit 16, and a fuel pump unit 18. The fuel tank 12 is made from a resin material and has a hollow reservoir shape. The fuel tank 12 has a top wall 20 and a bottom wall 21, both of which extend horizontally. The top wall 20 includes a high wall part 22 at a left portion thereof. The high wall part 22 protrudes upward relative to the other parts of the top wall 20. An opening 23, which has a circular shape, is formed at a central portion of the top wall 20. The portion of the top wall 20 defining the outer periphery of the opening 23 may also be referred to herein as the opening periphery 24. The fuel tank 12 is positioned such that the high wall part 22 is positioned adjacent to a lower side of a body floor 25 of the vehicle.

The lid member 14 is made from a resin material and includes a lid body 27 having a circular plate shape. The lid body 27 includes an outer flange 28 at an outer circumferential part thereof having an outer diameter slightly larger than the diameter of the opening 23 of the fuel tank 12. A fitting cylindrical part 29 is disposed at a lower surface of the lid body 27. The fitting cylindrical part 29 has a hollow short cylindrical shape and is configured to be fitted into the opening 23 of the fuel tank 12. Inside the fitting cylindrical part 29, a pair of right and left guide rods 30 extend downward from the lid body 27. The flange 28 may also be referred to herein as the “outer circumferential part” of the lid body 27.

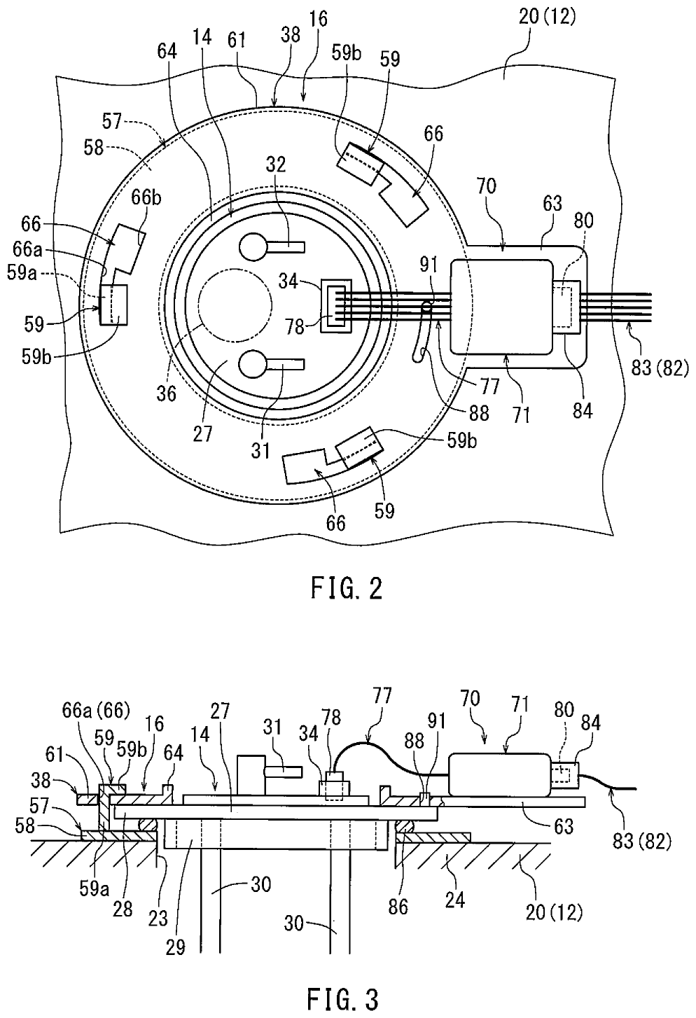

The lid body 27 includes a fuel delivery port 31 and an electric connector 34. In addition, the lid member 14 includes a fuel vapor discharge port 32 and a ventilation valve 36 (see FIG. 2). The ventilation valve 36 may be an evaporated fuel control valve, a refueling control valve, a roll over valve, etc. Each of the fuel delivery port 31 and the fuel vapor discharge port 32 may also be referred to herein as a “connection member” or “pipe connection member” in the present disclosure. The electric connector 34 may be referred to as “connection member” or“wire connection member.”

The lid member 14 is attached to the top wall 20 to close the opening 23 of the fuel tank 12. The fitting cylindrical part 29 is fitted into the opening 23, with the flange 28 seated on the opening periphery 24. The flange 28 is held between a lock ring 38 of the lock ring unit 16 and the opening periphery 24 of the fuel tank 12.

The fuel pump unit 18 is inserted into the fuel tank 12 through the opening 23 before the lid member 14 is fitted into the opening 23 of the fuel tank 12. The fuel pump unit 18 includes a reservoir cup 40, a fuel pump 42, a pressure regulator 44, a fuel sender gauge 46, and a pressure sensor 47, etc.

The reservoir cup 40 has a hollow cylindrical shape with an open top and a closed bottom. The reservoir cup 40 is disposed on the bottom wall 21 of the fuel tank 12. The reservoir cup 40 is moveably coupled to the guide rods 30 of the lid member 14, and can move vertically within a predetermined range. Between the lid member 14 and the reservoir cup 40, a biasing member (not shown), such as a spring, biases the lid member 14 and the reservoir cup 40 in mutually opposed directions. Accordingly, the reservoir cup 40 is always elastically biased toward and pressed against the bottom wall 21 of the fuel tank 12. The fuel pump unit 18 includes a jet pump (not shown), which is operated by pressurized fuel discharged from the fuel pump 42 so as to transfer fuel stored in the fuel tank 12 into the reservoir cup 40.

The fuel pump 42 is vertically mounted and supported in the reservoir cup 40. The fuel pump 42 may be a motor integrated fuel pump. The fuel pump 42 is electrically connected to the electric connector 34 of the lid member 14 via a lead wire 48. A fuel outlet of the fuel pump 42 is coupled to the fuel delivery port 31 via a communication pipe (not shown). The fuel pump 42 is configured to suction the fuel stored in the reservoir cup 40, to pressurize and discharge it toward the engine via the fuel delivery port 31. The fuel pump 42 may also be refeed to herein as an “electrical component.”, and the lead wire 48 may also be referred to herein as an“electrical wire.”

The pressure regulator 44 is configured to control pressure of the fuel to be supplied to the engine at a predetermined controlled pressure value. The fuel sender gauge 46 is a fuel sensor configured to detect the remaining amount of the fuel in the fuel tank 12. The fuel sender gauge 46 includes a gauge body 50 attached to the reservoir cup 40, an arm 51 supported by a rotatable component of the gauge body 50 in a cantilever-like manner, and a float 52 attached to a free end of the arm 51. The gauge body 50 is electrically connected to the electric connector 34 of the lid member 14 via a lead wire 53. The fuel sender gauge 46 may also be referred to as an “electrical component,” and the lead wire 53 may also be referred to herein as an “electrical wire.”

The pressure sensor 47 is attached to the reservoir cup 40. The pressure sensor 47 is configured to detect pressure in the fuel tank 12. The pressure sensor 47 is electrically connected to the electric connector 34 of the lid member 14 via a lead wire 55. The pressure sensor 47 may also be referred to herein as an “electrical component,” and the lead wire 55 may also be referred to herein as an “electrical wire.”

Referring now to FIGS. 2 and 3, the fixing structure for securing the lid member 14 to the top wall 20 of the furl tan 12 includes a base member 57 and the lock ring unit 16. The base member 57 may be made from a metal material and includes a ring plate 58 and locking pieces 59. The ring plate 58 is an annular plate coaxially integrated with an upper surface of the opening periphery 24 of the fuel tank 12. A plurality (three shown in FIG. 2) of the locking pieces 59 are formed on the ring plate 58 at regular intervals in the circumferential direction. As illustrated in FIG. 7, each locking piece 59 includes a vertical part 59a extending upward from the ring plate 58 and a locking projection part 59b protruding radially inward from an upper end of the vertical part 59a.

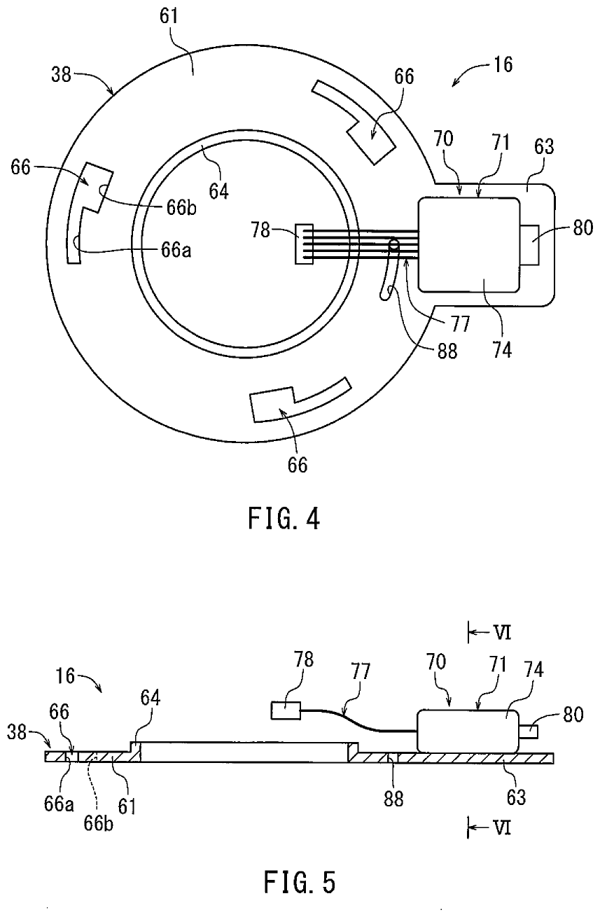

Referring now to FIGS. 4 and 5, the lock ring unit 16 includes the lock ring 38 and a controller 70. The lock ring 38 is made from a metal material and has a ring body 61 and a controller mounting part 63. The ring body 61 is an annular plate (see FIG. 4). The ring body 61 includes a cylindrical wall 64 extending upward from an inner periphery of the ring body 61. The ring body 61 may also be referred to herein as a “body part.”

As best shown in FIG. 4, a plurality of arc-shaped locking holes 66 are formed in the ring body 61. The number of the locking holes 66 is the same as the number of the locking pieces 59 of the base member 57 (see FIG. 2). Each locking hole 66 includes a narrow part 66a, extending in the circumferential direction, and a wide part 66b formed at one end (in the present embodiment, a leading end in the clockwise direction in the plan view) of the narrow part 66a to increase the width of the locking hole 66 radially inward (see FIG. 7). The locking pieces 59 and the locking holes 66 are arranged to form a twist lock mechanism. The number of the locking pieces 59 and the number of the locking holes 66 may be increased from the numbers shown in FIG. 2.

As illustrated in FIG. 2, the controller mounting part 63 projects radially outward from the ring body 61. The controller mounting part 63 has a rectangular plate shape in the plan view. The ring body 61 and the controller mounting part 63 are formed on one plane (see FIG. 5). The controller mounting part 63 is disposed at a position adjacent to the electric connector 34 of the lid member 14, that is, at a right end part of the ring body 61. In particular, the controller mounting part 63 is positioned such that a center of the ring body 61, the electric connector 34 and the controller mounting part 63 are linearly aligned (in order) in the plan view where the fuel supply device 10 is viewed from the above. The lock ring 38 may also be referred to herein as a “ring member.”

As illustrated in FIG. 3, the controller 70 is attached to an upper surface of the controller mounting part 63. The upper surface of the controller mounting part 63 corresponds to a surface on the opposite side to the fuel tank 12 side.

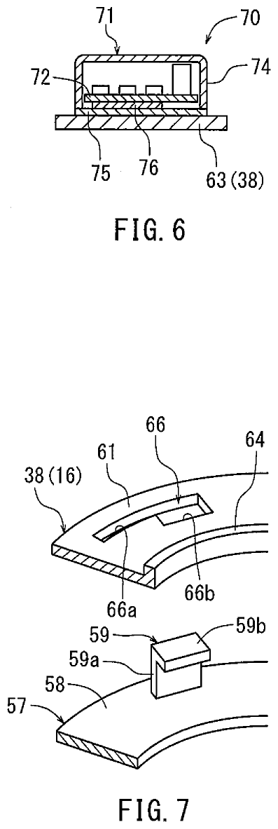

As illustrated in FIG. 6, the controller 70 includes an outer controller casing 71 and a horizontally oriented circuit board 72 disposed in the controller casing 71. The controller casing 71 has a rectangular box shape with a low height. On the circuit board 72, electronic components forming a control circuit are installed. The controller casing 71 includes a casing body 74 having an open bottom, and a casing lid 75 closing the bottom opening of the casing body 74. A heat transmitting member 76, which is made from a material having a high thermal conductivity, is secured between mutually facing surfaces of the circuit board 72 and the casing lid 75.

As best shown in FIG. 5, the controller 70 also includes a wire harness 77 extending from a left surface of the casing body 74, which is positioned at one end in the longitudinal direction of the casing body 74. A leading end of the wire harness 77 is provided with an electric connector 78. The controller 70 includes an electric connector 80 at a right surface of the casing body 74, which is positioned at the other end in the longitudinal direction of the casing body 74. The wire harness 77 may also be referred to herein as “electrical wire.”

The controller 70 is horizontally mounted on the upper surface of the controller mounting part 63 of the lock ring 38. The controller 70 is substantially disposed within a projected area of the controller mounting part 63 in the plan view (see FIG. 4). The controller 70 is disposed outside an area defined by the inner diameter of the lock ring 38. The casing lid 75 is mounted on the controller mounting part 63 in a surface contact manner (see FIG. 6). The longitudinal direction of the controller 70 is generally aligned with the radial direction of the ring body 61 (see FIG. 4). The electric connector 80 is directed radially outward relative to the ring body 61 (rightward).

As illustrated in FIG. 3, to secure the lid member 14 on the fuel tank 12, the lid member 14 is fitted into the opening 23 of the fuel tank 12. More specifically, the fitting cylindrical part 29 of the lid member 14 is fitted into the opening 23, such that the flange 28 of the lid member 14 is disposed over the ring plate 58 of the base member 57. An O-ring 86 is disposed between the flange 28 and the ring plate 58.

Next, the wide part 66b of each locking hole 66 of the lock ring 38 of the lock ring unit 16 is fitted with the locking projection part 59b of each locking piece 59 of the base member 57, such that the ring body 61 of the lock ring 38 is disposed on the flange 28 of the lid member 14.

Next, the lock ring 38 is rotated in the clockwise direction in the plan view with the lock ring 38 is pressed against the elastic force of the O-ring 86, such that the vertical part 59a of each locking piece 59 moves circumferentially from the wide part 66b into the narrow part 66a of each locking hole 66. Then, the pressing force applied to the lock ring 38 is released. As a result, an opening periphery part of the narrow part 66a of each locking hole 66 is engaged with the locking projection part 59b of each locking piece 59 due to elastic restoring force of the O-ring 86, thereby locking the lock ring 38.

The flange 28 of the lid member 14 is held between the opening periphery 24 of the fuel tank 12 and the lock ring 38. In particular, the lock ring 38 holds the flange 28 of the lid member 14 between the opening periphery 24 of the fuel tank 12 and the lock ring 38. The controller 70 is disposed at a position adjacent to the electric connector 34 of the lid member 14. In this manner, the lid member 14 is fixed on the fuel tank 12. The lid member 14 can be removed from the fuel tank 12 by performing the steps described above in reverse order.

The ring body 61 of the lock ring 38 includes a pin slot 88 positioned radially inside the controller mounting part 63. The pin slot 88 has an are shape that is a part of a concentric circle of the ring body 61 having a smaller diameter than the ring body 61 (see FIG. 2). A pin 91 protruding upward (see FIG. 3) is formed on the flange 28 of the lid member 14 by integral molding. The pin 91 is configured to be engaged within the pin slot 88.

When the locking projection part 59b of each locking piece 59 of the base member 57 is passed through the wide part 66b of each locking hole 66 of the lock ring 38, the pin 91 is advanced into one end part (a leading end part in the clockwise direction in the plan view) of the pin slot 88. Accordingly, the ring body 61 can be disposed on the flange 28 of the lid member 14. Then, when the lock ring 38 is rotated in the clockwise direction in the plan view, the pin 91 moves relative to the pin slot 88 such that the pin 91 is finally located at the other end part (a leading end part in the counterclockwise direction in the plan view) of the pin slot 88 (see FIG. 2).

When the locking projection part 59b of each locking piece 59 is aligned with and put into the wide part 66b of each locking slot 66 with the ring body 61 in an incorrect position relative to the base member 57 by 120 degrees in the circumferential direction (i.e. the clockwise direction or the counterclockwise direction in the plan view), the pin 91 interferes with the ring body 61, so that the ring body 61 cannot be laid over the flange 28. Accordingly, an erroneous assembly of the ring body 61 on the base member 57 is evident. In such case, the assembly process of the lock ring 38 should be done over again. The pin 91 may be formed to be separate from the flange 28 and may be attached to the flange 28 by press fitting, screw fastening, fastening, or the like, instead of integral molding with the flange 28 of the lid member 14.

The fuel delivery port 31 of the lid member 14 is coupled to a fuel supply pipe (not illustrated), which is connected to the engine, in a state where the lid member 14 is locked. The fuel vapor discharge port 32 (see FIG. 2) is coupled to a fuel vapor pipe (not illustrated), which is connected to a canister. The electric connector 78 of the controller 70 is coupled to the electric connector 34. An electric connector 84 of a wire harness 83 of an electronic control unit (ECU) 82 (see FIG. 1) is connected to the electric connector 80 of the controller 70.

The controller 70 is configured to control the operation of the fuel pump 42 on the basis of both information of the engine operating status, such as the number of rotations, or the opening degree of an acceleration pedal, from the ECU 82, and detection signals from various sensors. Other functions of the controller 70 include signal processing and power supply for the fuel sender gauge 46, signal processing and power supply for the pressure sensor 47, calculation and integrity control on the basis of a plurality of control signals, and so on.

The lid member 14, the lock ring unit 16, and the controller 70 are disposed in a space between the body floor 25 and a low wall part of the top wall 20 of the fuel tank 12 adjacent the high wall part 22 (see FIG. 1).

Next, the operation of the fuel supply device 10 will be described with reference to FIG. 1. The fuel in the reservoir cup 40 is suctioned and pressurized due to the operation of the fuel pump 42, and then is supplied to the engine via the communication pipe, the fuel delivery port 31, and the fuel supply pipe. The pressure of the fuel to be supplied to the engine is adjusted at a predetermined controlled pressure value by the pressure regulator 44. The fuel vapor evaporated in the fuel tank 12 is discharged from the fuel vapor discharge port 32 (see FIG. 2) into the canister via the fuel vapor pipe.

In accordance with the fuel supply device 10, the controller 70 is mounted on the lock ring 38, which holds the flange 28 of the lid member 14 between the fuel tank 12 and the lock ring 38. Accordingly, it is able to overcome disadvantages, such as an increase in size of the lid member 14, and restriction of the degree of freedom in arrangement of the connection members (i.e. the fuel delivery port 31, the fuel vapor discharge port 32, and the electric connector 34), which are caused by mounting the controller 70 on the lid member 14. As a result, while the mountability of the controller 70 can be improved, the controller 70 can be disposed adjacent to the fuel tank 12.

The controller 70 is disposed at the position adjacent to the electric connector 34 of the lid member 14. Accordingly, in comparison with a case where the controller 70 is not adjacent to the electric connector 34 of the lid member 14, the length of the wire harness 77 between the electric connector 34 of the lid member 14 and the controller 70 can be decreased, thereby reducing the cost and electromagnetic noises.

The controller 70 is disposed within the projected area of the controller mounting part 63 in the plan view. Accordingly, the controller mounting part 63 can protect the controller 70 from an external force in the horizontal direction (in the radially outward direction or the circumferential direction of the lock ring 38). Further, the lock ring 38 can be operated by using the controller mounting part 63 as a holding part during attachment and detachment of the lock ring 38 with respect to the fuel tank 12. Accordingly, the operability of the lock ring 38 can be improved.

The controller 70 is mounted on the lock ring 38 that is made from the metal material, so that heat generated by the controller 70 can be efficiently transmitted to the lock ring 38, and then can be radiated from the lock ring 38. Accordingly, it enables the lock ring 38 to function as a heat sink, thereby suppressing an increase in the temperature of the contoller 70. Due to this, a high power type controller 70 may be used, and it is easy to deal with variations. If the controller 70 is mounted on the lid member 14 that is made from a resin material, the heat dissipation of the controller 70 is relatively low, such that the lid member 14 may be adversely affected. Thus, there are some disadvantages, e.g. power consumption by the controller 70 is restricted, or it is hard to deal with variations. However, in accordance with the first embodiment, such disadvantages can be overcome. The casing lid 75 is preferably made from a high heat conductive material, because the casing lid 75 of the controller casing 71 serves as a heat transmitting part for transmitting heat generated by electronic components on the circuit board 72 to the controller mounting part 63 of the lock ring 38.

The lock ring 38 is adjacent to the lid member 14 such that a positional relationship between a center of the lid member 14 and the controller 70 is fixed, thereby advantageously allowing stabilization of the position of the controller 70, wiring, and electromagnetic noises. The metal lock ring 38 provides secure fixation strength, such as vibration resistance. The controller 70 is mounted on the lock ring 38, so that an increase in the number of components can be avoided. The size of the lock ring 38 is standardized, so that it is capable of facilitating variation compatibility.

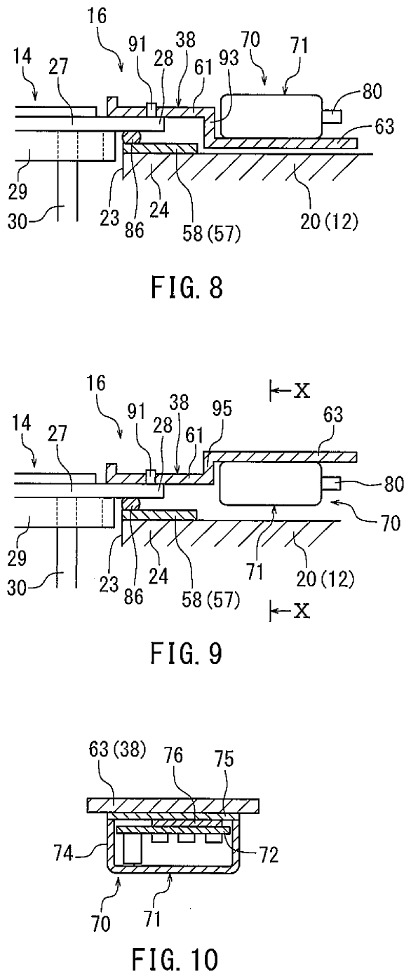

A second embodiment corresponds to the first embodiment (see FIG. 3), with some changes relating to an arrangement structure of the controller 70. Accordingly, the changes will be described, and repetitive explanations will be omitted. As shown in FIG. 8, a step 93 is formed between the ring body 61 and the controller mounting part 63 of the lock ring 38. Due to the step 93, the controller mounting part 63 is shifted toward the fuel tank 12 side (downward) relative to the ring body 61.

In accordance with the second embodiment, the controller 70 can be disposed near the fuel tank 12 while mounting the controller 70 on the upper surface (the opposite side to the fuel tank 12 side) of the controller mounting part 63 of the lock ring 38. Accordingly, the entire height (the vertical size) of the fuel supply device 10 including the controller 70 can be decreased, thereby improving mountability of the fuel supply device 10 (see FIG. 1) on the vehicle. Furthermore, it is possible to decrease the distance required for the space between the body floor 25 and the low wall part of the top wall 20 of the fuel tank 12 adjacent the high wall part 22.

A third embodiment corresponds to the first embodiment (see FIG. 3), with some changes elating to the arrangement structure of the controller 70. Accordingly, the changes will be described, and repetitive explanations will be omitted. As shown in FIG. 9, a step 95 is formed between the ring body 61 and the controller mounting part 63 of the lock ring 38. Due to the step 95, the controller mounting part 63 is shifted toward the opposite side to the fuel tank 12 (upward) relative to the ring body 61. As illustrated in FIG. 10, the controller 70 is horizontally mounted on a fuel tank 12 side surface (lower surface) of the controller mounting part 63 in a state where the controller 70 is reversed upside down.

In accordance with the third embodiment, the controller 70 can be arranged near the fuel tank 12 by mounting the controller 70 on the lower surface (the fuel tank 12 side) of the controller mounting part 63 of the lock ring 38. Accordingly, the entire height of the fuel supply device 10 (see FIG. 1) including the controller 70 can be decreased, thereby improving the mountability of the fuel supply device 10 on the vehicle. Further, the controller mounting part 63 is shifted toward the opposite side to the fuel tank 12 (upward) relative to the ring body 61. Accordingly, even if the distance between the top wall 20 of the fuel tank 12 and the controller mounting part 63 is small, it is able to prevent the controller 70 from interfering with the top wall 20. Alternately, even if the distance between the top wall 20 of the fuel tank 12 and the ring body 61 is large, the step 95 may be omitted.

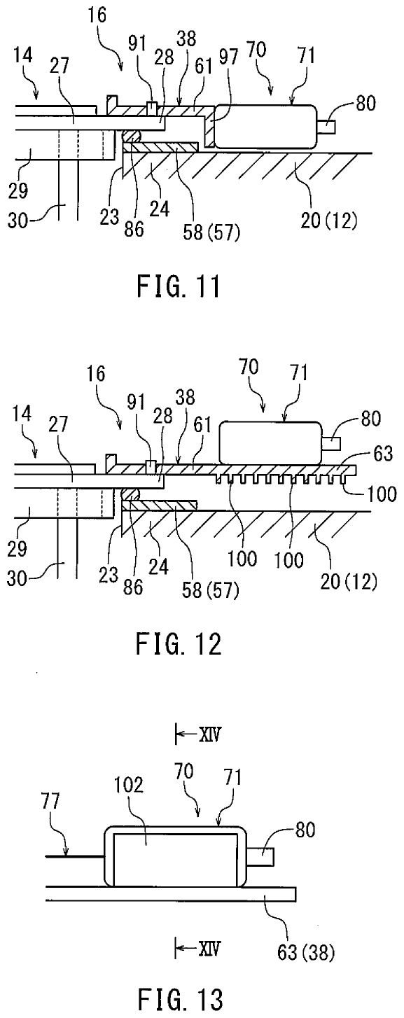

A fourth embodiment corresponds to the first embodiment (see FIG. 3), with some changes relating to the arrangement structure of the controller 70. Accordingly, the changes will be described, and the repetitive explanations will be omitted. As shown in FIG. 11, the lock ring 38 of the fourth embodiment includes a controller mounting part 97, which extends from an outer periphery of the ring body 61 in the axial direction (downward in the present embodiment) by bending. The vertical size of the controller mounting part 97 is set to be less than the distance between the top wall 20 of the fuel tank 12 and the ring body 61. The controller 70 is horizontally mounted on an outer side surface (right side surface) of the controller mounting part 97. In the fourth embodiment, the wire harness 77 (see FIG. 5) of the controller 70 extends from the sides of the casing body 74 except the left side surface thereof.

In accordance with the fourth embodiment, the controller 70 is disposed radially outside the controller mounting part 97 of the lock ring 38 so as to decrease the entire height of the fuel supply device 10 (see FIG. 1) including the controller 70. Accordingly, the mountability of the fuel supply device 10 on the vehicle can be improved.

A fifth embodiment corresponds to the first embodiment (see FIG. 3), with some changes relating to the lock ring 38. Accordingly, the changes will be described, and repetitive explanations will be omitted. As shown in FIG. 12, a plurality of heat dissipation fins 100 are formed at the lower surface of the controller mounting part 63 of the lock ring 38. The heat dissipation fins 100 may also be referred to herein as a “heat dissipation mechanism.”

In accordance with the fifth embodiment, heat generated by the controller 70 can be radiated from the heat dissipation fins 100 of the lock ring 38. Accordingly, it is able to prevent thermal deterioration of the controller 70, the resin-made lid member 14, etc. The heat dissipation fins 100 may be arranged on the upper surface of the ring body 61. Alternately, a heat dissipation member, made of a material having a high thermal conductivity, may be provided on the controller mounting part 63 and/or the ring body 61 as the heat dissipation mechanism, instead of the heat dissipation fins 100.

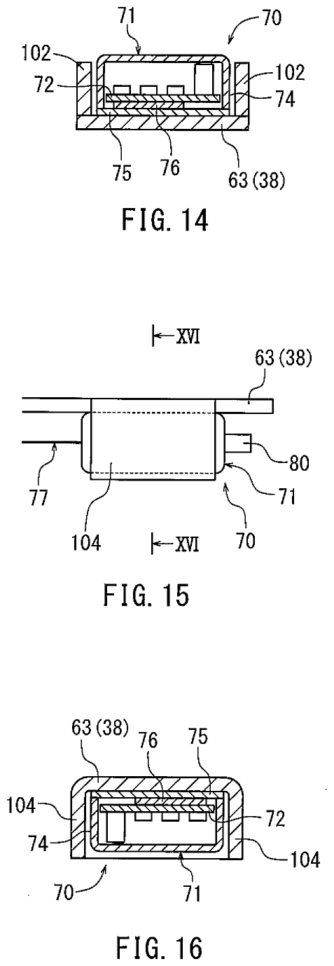

A sixth embodiment corresponds to the first embodiment (see FIGS. 5 and 6) with some changes relating to the controller mounting part 63 of the lock ring 38. Accordingly, the changes will be described, and repetitive explanations will be omitted. As shown in FIGS. 13 and 14, a pair of side walls 102 are attached to both ends of the controller mounting part 63 of the lock ring 38 in the transverse direction of the controller mounting part 63 for covering the both sides of the controller casing 71. The side walls 102 are made of the same material as the lock ring 38. The side walls 102 may be formed by bending.

In accordance with the sixth embodiment, the side walls 102 of the controller mounting part 63 of the lock ring 38 can radiate heat generated by the controller 70. In addition, the side walls 102 serve as a protector for protecting the controller 70 from an impact by an external force (e.g., flying stone, or water). The side walls 102 may also be referred to herein as a “heat dissipation mechanism.”

A seventh embodiment corresponds to the third embodiment (see FIGS. 9 and 10) with some changes relating to the controller mounting part. Accordingly, the changes will be described, and repetitive explanations will be omitted. As shown in FIGS. 15 and 16, at both ends of the controller mounting part 63 of the lock ring 38 in the transverse direction of the controller mounting part 63, a pair of side walls 104 extending downward are formed by bending to cover both sides of the controller casing 71. The side walls 104 may be provided by attachment.

In accordance with the seventh embodiment, the side walls 104 of the controller mounting part 63 of the lock ring 38 can radiate heat generated by the controller 70. Further, the side walls 104 serve as a protector for protecting the controller 70 from an impact by an external force (e.g., flying stone, or water). The side walls 104 may be referred to as the “heat dissipation mechanism” in the present disclosure.

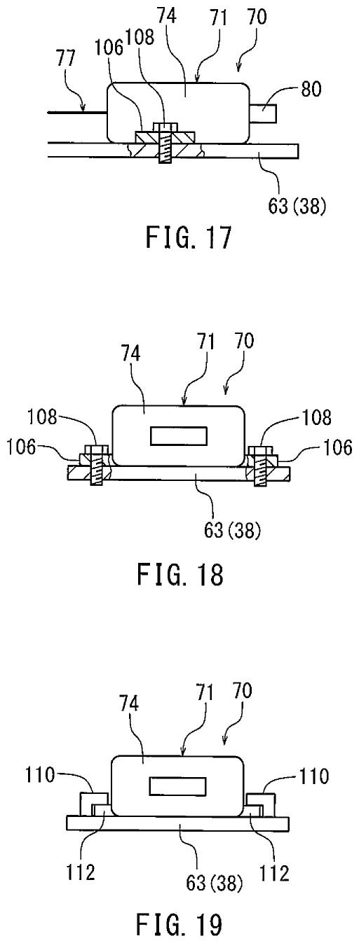

An eighth embodiment corresponds to the first embodiment (see FIG. 5) with some changes relating to the mounting structure of the controller 70. Accordingly, the structure will be described, and repetitive explanations will be omitted. As shown in FIGS. 17 and 18, a pair of mounting pieces 106 are formed at lower ends of both sides of the casing body 74 of the controller casing 71 of the controller 70 in the transverse direction of the casing body 74. The mounting pieces 106 are fastened on the controller mounting part 63 of the lock ring 38 with bolts 108. Due to this, the controller 70 is mounted on the controller mounting part 63 of the lock ring 38.

A ninth embodiment corresponds to the first embodiment (see FIG. 5) with some changes relating to the mounting structure of the controller 70. The changes will be described, and repetitive explanations will be omitted. As shown in FIG. 19, a pair of guide rails 110 are formed at upper surfaces of both end parts of the controller mounting part 63 of the lock ring 38 in the transverse direction of the controller mounting part 63. The guide rails 110 extend in the longitudinal direction (a direction of the front and rear sides of paper of FIG. 19). Each of the guide rails 110 has an L-shaped cross-section, including a vertical part extending upward from the controller mounting part 63 and an upper horizontal part extending horizontally from an upper end of the vertical part. The guide rails 110 are arranged in linear symmetry such that the upper horizontal parts of the guide rails are directed toward each other. A pair of mounting rails 112 are formed in linear symmetry at lower ends of both sides of the casing body 74 of the controller casing 71 of the controller 70 in the transverse direction of the casing body 74. The mounting rails 112 extend in the longitudinal direction (a direction of the front and rear sides of paper of FIG. 19).

The mounting rails 112 of the controller 70 are slid along and engaged with the guide mils 110 of the controller mounting part 63 of the lock ring 38. In this way, the controller 70 is mounted on the controller mounting part 63. Further, a prevention means (not shown), such as a lock claw or a stopper, is provided between the controller mounting part 63 and the controller 70 for preventing movement of the controller 70 in a sliding direction thereof (a direction of the front and rear sides of paper of FIG. 19) so as to hold the controller 70 at its fixing position.

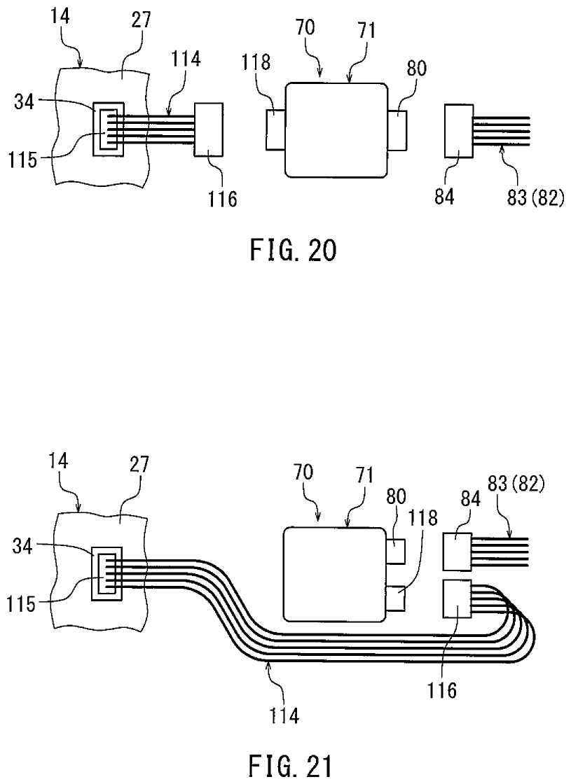

A tenth embodiment corresponds to the first embodiment (see FIG. 2) with some changes relating to the wire harness 77 between the controller 70 and the electric connector 34 of the lid member 14. Accordingly, the changes will be described, and repetitive explanation will be omitted. As illustrated in FIG. 20, a relay wire harness 114 replaces the wire harness 77 of the controller 70 of the first embodiment (see FIG. 2). The ends of the relay wire harness 114 are provided with electric connectors 115, 116. The electric connector 115 is connected to the electric connector 34 of the lid member 14. The electric connector 116 is configured to be connected to an electric connector 118 provided on the opposite side of the controller 70 to the electric connector 80.

An eleventh embodiment corresponds to the tenth embodiment (see FIG. 20) with some changes relating to the controller 70. Accordingly, the changes will be described, and repetitive explanations will be omitted. As shown in FIG. 21, in the tenth embodiment, the electric connector 80 and the electric connector 118 of the controller 70 are arranged side by side. The electric connectors 80, 118 of the controller 70 are connected to the electric connector 84 of the wire harness 83 and the electric connector 116 of the relay wire harness 114 from the same direction, respectively. In this embodiment, the length of the relay wire harness 114 is longer than that of the tenth embodiment (see FIG. 20).

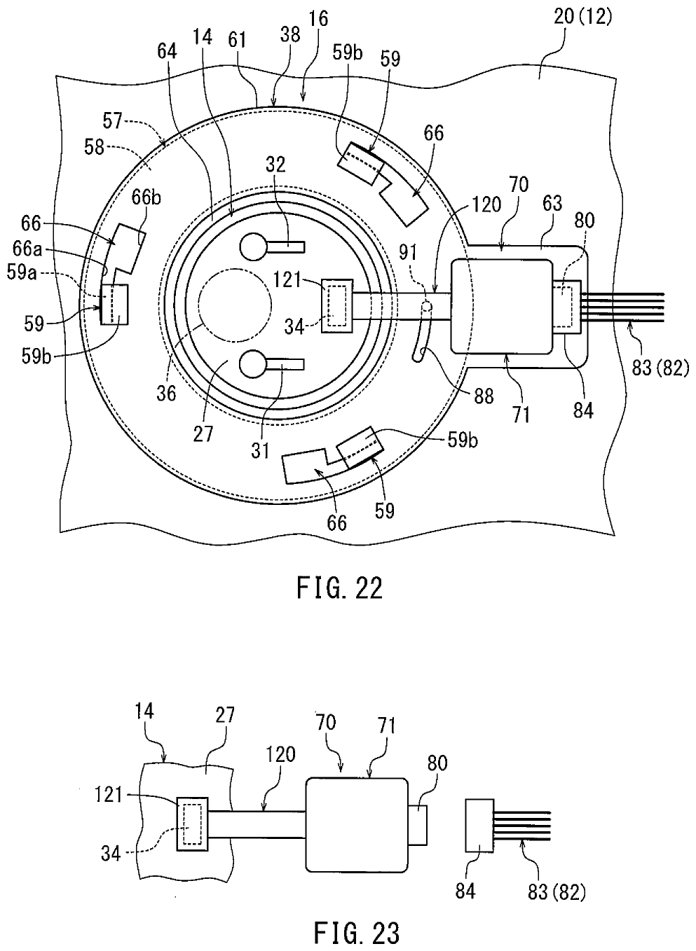

A twelfth embodiment corresponds to the first embodiment (see FIG. 2) with some changes relating to the controller 70. Accordingly, the changes will be described, and repetitive explanations will be omitted. As shown in FIGS. 22 and 23, a harness member 120 is provided on the controller casing 71, instead of the wire harness 77 of the controller 70 of the first embodiment (see FIG. 2). The harness member 120 is formed by resin-molding with a wire harness. One end of the harness member 120 is provided with an electric connector 121. The electric connector 121 is connected to the electric connector 34 of the lid member 14.

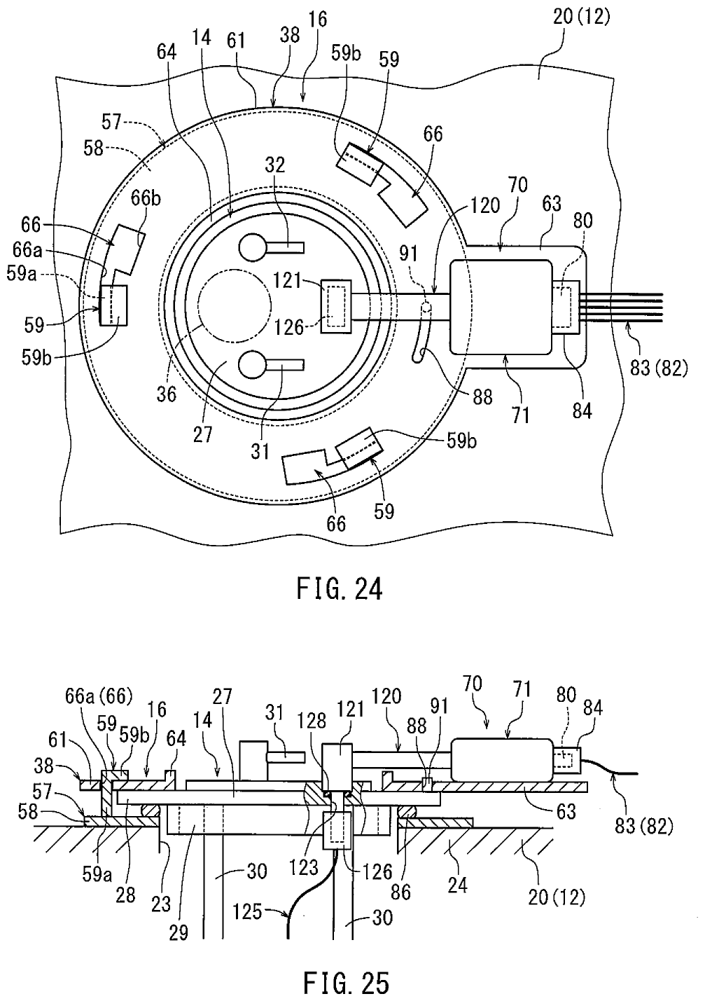

A thirteenth embodiment corresponds to the twelfth embodiment (see FIGS. 22 and 23) with some changes relating to the electric connector 34 of the lid member 14. Accordingly, the changes will be described, and repetitive explanations will be omitted. As shown in FIGS. 24 and 25, the electric connector 34 of the lid member 14 according to the twelfth embodiment (see FIGS. 22 and 23) is omitted. As illustrated in FIG. 25, the lid member 14 has a connector fitting hole 123 penetrating therethrough in the vertical direction. The electric connector 121 of the controller 70 is configured to be fitted into the connector fitting hole 123. The electric connector 121 is connected to an electric connector 126 of a wire harness 125 of an electrical component (such as the fuel pump, the fuel sender gauge, or the pressure sensor) disposed within the fuel tank 12. An O-ring 128 is disposed between the lid member 14 and the electric connector 121 for sealing therebetween.

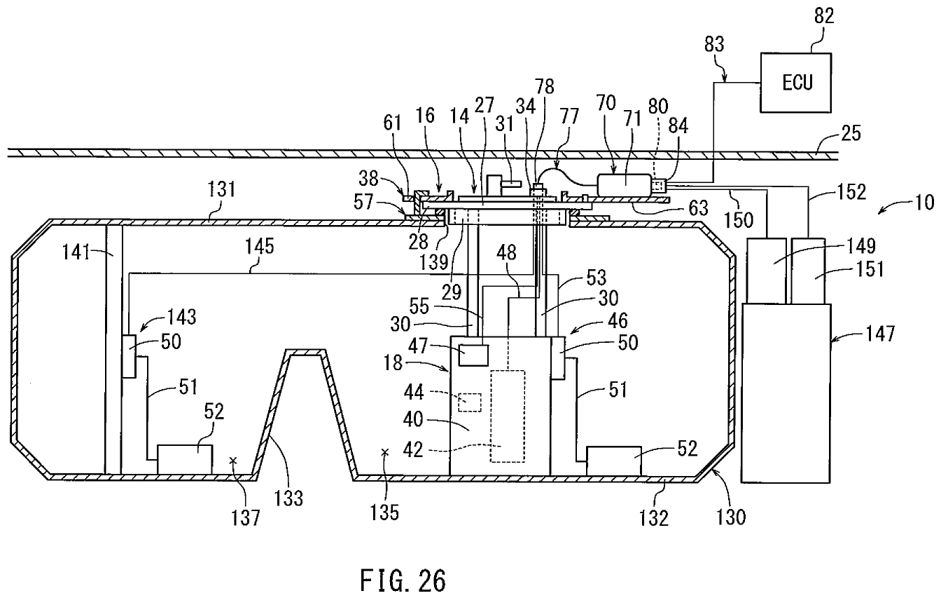

A fourteenth embodiment corresponds to the first embodiment (see FIG. 1) with some changes relating to the fuel supply device 10. The changes will be described, and repetitive explanations will be omitted. As illustrated in FIG. 26, a fuel tank 130 replaces the fuel tank 12 of the first embodiment. The fuel tank 130 is a saddle-shaped fuel tank. The fuel tank 130 includes a top wall 131 and a bottom wall 132, both of which extend horizontally. The bottom wall 132 includes a partition wall part 133 protruding upward. The partition wall 133 divides a space within a lower portion of the fuel tank 130 into a main reservoir part 135 and an auxiliary reservoir part 137. The top wall 131 has an opening 139 corresponding to a central portion of the main reservoir part 135.

The lid member 14, the lock ring unit 16, the fuel pump unit 18, and other components are disposed in the main reservoir part 135 of the fuel tank 130. The fuel pump unit 18 is provided with a jet pump and its fuel pipe (not shown) for transferring fuel in the auxiliary reservoir part 137 into the reservoir cup 40 by utilizing the pressurized fuel discharged from the fuel pump 42.

A support column 141 is disposed upright in the auxiliary reservoir part 137. The support column 141 is provided with an auxiliary fuel sender gauge 143 serving as a fuel sensor for detecting the remaining amount of the fuel in the auxiliary reservoir part 137. Because the auxiliary fuel sender gauge 143 has the same structure as the fuel sender gauge 46, the same parts are followed by the same reference signs so as to omit explanation thereof. The gauge body 50 of the auxiliary sender gauge 143 is electrically connected to the electric connector 34 of the lid member 14 via a lead wire 145. The auxiliary fuel sender gauge 143 may also be referred to herein as an “electrical component.” The lead wire 145 may be referred to as the “electrical wire” in the present disclosure.

An adsorbent canister 147 is disposed outside the fuel tank 130. The adsorbent canister 147 includes an electromagnetic valve 149 configured to control release of fuel vapor adsorbed in the adsorbent canister 147 toward an air intake system of the engine, and a pressure sensor 151 configured to detect pressure in the adsorbent canister 147. The electromagnetic valve 149 is electrically connected to the controller 70 via a lead wire 150. The pressure sensor 151 is electrically connected to the controller 70 via a lead wire 152.

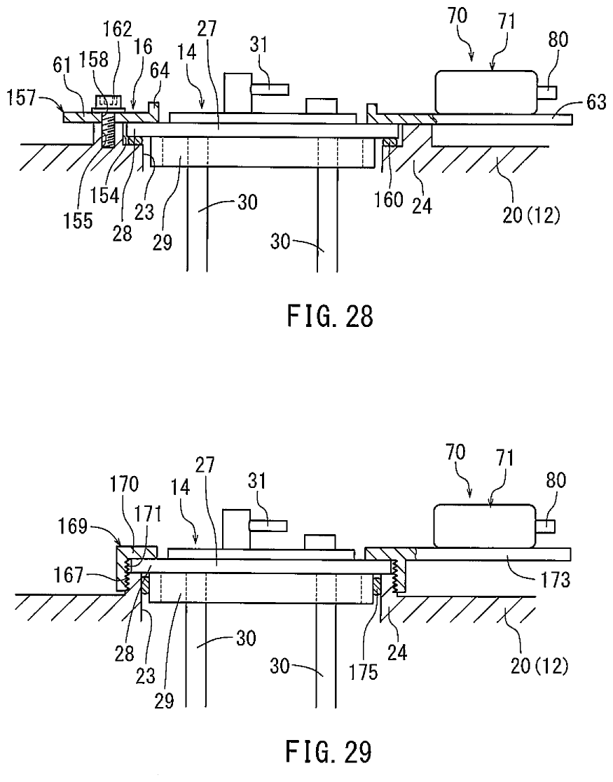

A fifteenth embodiment corresponds to the first embodiment (see FIGS. 2 and 3) with some changes relating to the fixing structure of the lid member 14. Accordingly, the changes will be described, and repetitive explanations will be omitted. As illustrated in FIG. 28, in the fifteenth embodiment, the base member 57 of the first embodiment (see FIGS. 2 and 3) is omitted. The thickness of the opening periphery 24 of the fuel tank 12 is increased in comparison with that of the opening periphery 24 of the first embodiment. A stepped recess 154 is formed at an inner circumferential part of an upper surface of the opening periphery 24. A plurality (e.g. five, one of them is illustrated in FIG. 28) of female screw holes 155 each opening upward are formed at the opening periphery 24 at a predetermined intervals in the circumferential direction.

Bolt through holes 158 of the same number (e.g. five, one of them is shown in FIG. 28) with the female screw holes 155 are formed in the ring body 61 at the regular intervals in the circumferential direction, instead of the locking holes 66 of the first embodiment. A ring member having the bolt through holes 158 is referred to as “press ring 157”. The press ring 157 may also be referred to herein as a “ring member.” In the fifteenth embodiment, the pin slot 88 of the ring body 61 and the pin 91 of the lid body 27 according to the first embodiment (see FIGS. 2 and 3) are omitted.

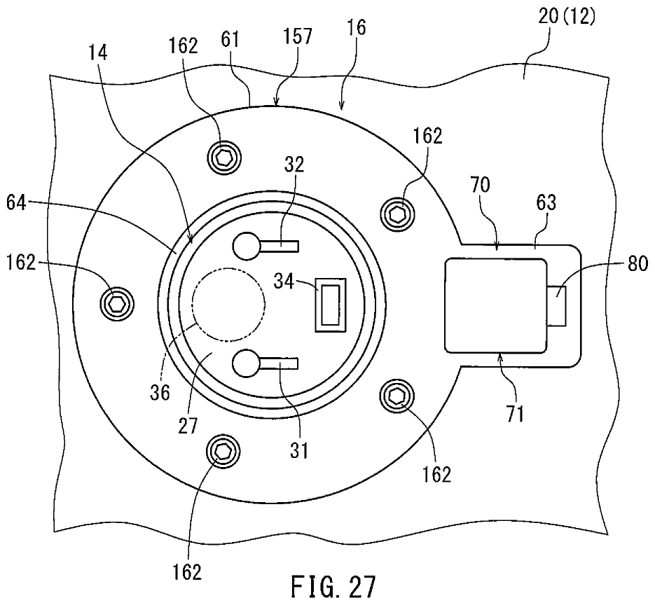

In order to fix the lid member 14 on the fuel tank 12, the lid member 14 is fitted into the opening 23 of the fuel tank 12. At this time, an O-ring 160 is disposed between axially mutually facing surfaces of the flange 28 of the lid member 14 and the stepped recess 154 of the opening periphery 24. Next, the ring body 61 of the press ring 157 is put on the flange 28 of the lid member 14. Then, fixing bolts 162 are passed through the bolt through holes 158 of the press ring 157 and are screwed into the female screw holes 155 of the opening periphery 24 of the fuel tank 12. The lid member 14 is fixed on the fuel tank 12 in this manner (see FIG. 27). The lid member 14 can be removed by reversing the order of the above-described steps. A hexagonal socket bolt may be used as each fixing bolt 162. In FIGS. 27 and 28, the wire harness 77 including the electric wire 78, and the wire harness 83 including the electric connector 78 are not illustrated. The fixing structure of the lid member 14 according to the fifteenth embodiment is preferable for the metal fuel tank 12. The number of the female screw holes 155, the number of the bolt through holes 158, and the number of the fixing bolts 162 may be increased or decreased from the numbers illustrated in FIG. 27.

A sixteenth embodiment corresponds to the first embodiment (see FIG. 3) with some changes relating to the fixing structure of the lid member 14. Accordingly, the changes will be described, and repetitive explanations will be omitted. As illustrated in FIG. 29, in the sixteenth embodiment, the base member 57 of the first embodiment (see FIG. 3) is omitted. The height of the opening periphery 24 of the fuel tank 12 is increased, and in particular, the opening periphery 24 protrudes upward, in comparison with that of the opening periphery 24 of the first embodiment. A male screw part 167 is formed on an outer circumferential surface of the opening periphery 24.

In addition, a support nut 169 is used instead of the lock ring 38 of the first embodiment (see FIG. 3). The support nut 169 includes a nut body 170 having a hollow cylindrical shape, and a controller mounting part 173 extending radially outward from the nut body 170. A female screw part 171 is formed on an inner circumferential surface of the nut body 170. The controller mounting part 173 has the same configuration as that of the controller mounting part 63 according to the first embodiment (see FIG. 3). The support nut 169 may also be referred to herein as the “ring member.” In the sixteenth embodiment, the pin slot 88 of the ring body 61 and the pin 91 of the lid body 27 according to the first embodiment am omitted.

In order to fix the lid member 14 on the fuel tank 12, the lid member 14 is fitted into the opening 23 of the lid member 14. At this time, an O-ring 175 is disposed between radially mutually facing surfaces of the fitting cylindrical part 29 of the lid member 14 and the opening periphery 24 of the fuel tank 12. Next, the female screw part 171 of the support nut 169 is screwed with the male screw part 167 of the opening periphery 24 of the fuel tank 12. The lid member 14 is fixed on the fuel tank 12 in this manner. The lid member 14 can be removed by reversing the order of the above-described steps. In FIG. 29, the wire harness 77 including the electric connector 78, and the wire harness 83 including the electric connector 78 are not illustrated.

The present disclosure is not limited to the above-described embodiments, and may be changed variously. For example, the fuel supply device of this disclosure may be applied to a fuel tank having an opening on a bottom wall thereof. Alternately, the mounting structure of the ring member on the fuel tank, and the mounting structure of the controller on the ring member may be changed as necessary.

The present disclosure discloses the technology in various configurations. A first configuration of the technology is a fuel supply device, which includes a fuel tank having an opening, a lid member closing the opening, a ring member holding an outer circumferential part of the lid member between the fuel tank and the ring member, and an electrical component disposed within the fuel tank. A controller for the electrical component is mounted on the ring member.

In accordance with the first configuration, the controller is mounted on the ring member, which holds the outer circumferential part of the lid member between the fuel tank and the ring member. Accordingly, it is able to overcome disadvantages caused by disposing the controller on the lid member, such as an increase in size of the lid member, or restriction of flexibility of arrangement of connection members. Therefore, the mountability of the controller can be improved while the controller is disposed adjacent to the fuel tank.

A second configuration is the fuel supply device of the first configuration, in which the controller is positioned adjacent to an electric connector provided on the lid member.

In accordance with the second configuration, in comparison with a case where the controller is not adjacent to the electric connector of the lid member, the length of a wire harness between the electric connector of the lid member and the controller can be decreased so as to reduce the cost and electromagnetic noises.

A third configuration is the fuel supply device of the first or second configuration, in which the ring member includes a controller mounting part protruding radially outward. The controller is mounted on an opposite side of the controller mounting part to a fuel tank side. The controller mounting part is shifted toward the fuel tank relative to a body part of the ring member.

In accordance with the third configuration, the controller can be disposed near the fuel tank while mounting the controller on the opposite side of the controller mounting part to the fuel tank side.

A fourth configuration is the fuel supply device of the first or second configuration, in which the ring member includes a controller mounting part protruding radially outward. The controller is mounted on a fuel tank side of the controller mounting part.

In accordance with the fourth configuration, the controller can be disposed near the fuel tank by mounting the controller on the fuel tank side of the controller mounting part of the ring member.

A fifth configuration is the fuel supply device of the first or second configuration, in which the ring member includes a controller mounting part protruding from an outer periphery of a body part of the ring member in a direction perpendicular to a plane where the body part of the ring member extends. The controller is disposed outside the controller mounting part.

In accordance with the fifth configuration, the entire height of the fuel supply device including the controller can be decreased by disposing the controller outside the controller mounting part of the ring member.

A sixth configuration is the fuel supply device of anyone of the fist to fifth configurations, in which the ring member includes a heat dissipation mechanism.

In accordance with the sixth configuration, it is able to radiate heat generated by the contoller due to the heat dissipation mechanism of the ring member.

1. A fuel supply device, comprising:
a fuel tank having an opening;
a lid member closing the opening;
a ring member holding an outer circumferential part of the lid member between the fuel tank and the ring member;
an electrical component disposed within the fuel tank, and
a controller configured to control the electrical component, wherein the controller is mounted on the ring member.

2. The fuel supply device according to claim 1, wherein the controller is positioned adjacent to an electric connector provided on the lid member.

3. The fuel supply device according to claim 1, wherein:
the ring member comprises a controller mounting part protruding radially outward;
the controller is mounted on an opposite side of the controller mounting part to a fuel tank side; and
the controller mounting part is shifted toward the fuel tank relative to a body part of the ring member.

4. The fuel supply device according to claim 1, wherein:
the ring member comprises a controller mounting part protruding radially outward; and
the controller is mounted on a fuel tank side of the controller mounting part.

5. The fuel supply device according to claim 1, wherein:
the ring member comprises a controller mounting part protruding from an outer periphery of a body part of the ring member in a direction perpendicular to a plane where the body part of the ring member extends; and
the controller is disposed outside the controller mounting part.

6. The fuel supply device according to claim 1, wherein the ring member includes a heat dissipation mechanism.
